(19) United States
(12) Patent Application Publication
(10) Pub. No.: US 2006/0222796 A1
(43) Pub. Date: Oct. 5, 2006

(54) Structure comprising metallized film and ethylene copolymer

(76) Inventor: Barry Alan Morris, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/098,754

(22) Filed: Apr. 4, 2005

(51) Int. Cl. B32B 27/08; B32B 15/08; B32B 27/34; B32B 27/36; B32B 27/30

(52) U.S. Cl. 428/35.7; 428/461; 428/522; 428/480; 428/475.5; 428/457; 156/244.22

(57) ABSTRACT

Disclosed are a multilayer structure, an article therewith, and a process therefor. The article includes packages such as pouch. The structure comprises a metallized film and an ethylene copolymer composition. The process is a lamination process or extrusion coating process with the ethylene copolymer composition providing adhesion of metallized film to a substrate.

This invention relates to a laminate or multilayer structure comprising or produced from a metallized film and a composition comprising an ethylene copolymer, to a process for adhering metallized film to a substrate, and to a product therewith such as package.

### BACKGROUND OF THE INVENTION

Metallized films are thermoplastic films having deposited (e.g., by vacuum) thereon a layer of metal such as aluminum. They are used in the food packaging industry as moisture and gas barriers. Metallized films can comprise polyesters such as polyethylene terephthalate (PET) or polypropylene (PP) as the thermoplastic film component. Polyethylene (PE) is also sometimes metallized. Often, metallized films are combined with other materials such as polyethylene (PE), oriented polypropylene (OPP), oriented PET (OPET), paper and paperboard in multilayer structures. These other materials may serve as, for example, abuse layers or sealant layers. They may also provide stiffness and a surface for printing. Thus, multilayer structures comprising metallized film layers adhered to thermoplastic compositions and other substrates can be used as packaging films. Applications include many dry food packages such as powdered drink mix pouches as well as non-packaging applications. Some common structures include multilayer structures having the following functional layers, wherein the sealant film serves as the innermost layer of the package: Abuse or Printing Layer/Adhesive/Metallized Film/Adhesive/Sealant Film. Examples of the abuse and/or printed layer include oriented polyethylene terephthalate, polypropylene, either oriented or cast, high density polyethylene (HDPE), paper, paperboard, and biaxally oriented nylon. Examples of the sealant film include low density polyethylene (LDPE), ethylene/vinyl acetate (EVA) copolymers, ionomers (i.e. partially neutralized ethylene/acid copolymers), and linear low density polyethylene (LLDPE).

An adhesive adheres the metallized surface of the film to the adjoining layer. For example, low-density polyethylene (LDPE) is used as an adhesive layer. Other adhesive layers include ethylene acid copolymers. See e.g., U.S. Pat. No. 6,165,610.

Adhesion of substrates to metallized film using LDPE can be accomplished by processing at high coating temperatures (300 to 330° C.) so that a portion of the polyethylene oxidizes. Oxidization of the LDPE creates polar species that provide moderate adhesion to the metallized surface.

In many applications, rather than using a coated layer of LDPE as the sealant, a LDPE or LLDPE film is used. For example, wherein the PE film serves as the innermost layer of the package: OPET/Adhesive/metallized-OPET/Adhesive/PE film. The PE film may be LDPE or LLDPE. A PE film can be made thicker than a coating, allowing for caulking of the seal interface; provide higher seal strength; have good strength and tear resistance; provide stiffness; be processed at lower temperatures than extrusion coating; and have less taste and odor problems (associated with the oxidation of the LDPE).

However, a substantial problem associated with using LDPE to extrusion laminate PE-films to metallized films is that the adhesion of the metallized layer to its base film “ages down” with time. Adhesion of LDPE to metallized film is only marginal to begin with, but over a time period of one to several weeks, the bond strength often declines to a level that is no longer functional for the application. One explanation may be that the aging is associated with secondary crystallinity of the LDPE. During the lamination process, the LDPE is quenched very quickly and little primary crystallization can occur. Over time, small “secondary” crystals may form. As PE crystallizes, it shrinks. Shrinkage can put a stress on bonds and reduce peel strength. The bond between the vacuum deposited metallized layer and its base film is the weakest of the bonds in the structure.

Often, more polar polymeric materials adhere to metallized film more readily than less polar materials. However, polar polymers that adhere well to metallized film may not adhere well to nonpolar polymers. Therefore, a tie layer providing a balance of properties that allow it to adhere both to metallized film and to non-polar polymers is desirable.

Chemical primers, used to promote adhesion to thermoplastic film substrates, add costs and may cause environmental concerns with solvent-based systems. It is desirable to develop composition or method for adhering metallized film to film or polymers without using primers.

### SUMMARY OF THE INVENTION

The invention includes a multilayer structure comprising, or produced from, (a) at least one layer of metallized film; (b) at least one composition comprising or produced from an ethylene copolymer; (c) optionally at least one substrate; and (d) further optionally at least one additional layer

This invention also includes a process comprising extruding a composition between a layer of metallized film and a substrate wherein the composition and substrate can be the same as disclosed above.

The invention further includes packages comprising the multilayer structure.

### DETAILED DESCRIPTION OF THE INVENTION

All references disclosed herein are incorporated by reference.

The substrate can comprise or be produced from a thermoplastic film, paper, paperboard, or combinations of two or more thereof. The additional layer can comprise or be produced from polyester, polyamide, polyethylene vinyl alcohol, polyethylene vinyl acetate, ethylene/acrylic acid copolymer, ionomer of ethylene/acrylic acid copolymer, polyvinylidene chloride, anhydride-modified ethylene polymer, or combinations of two or more thereof. The anhydride-modified ethylene polymer can be homopolymer, copolymer, or both. The thermoplastic film can comprise or be produced from ethylene/acrylic acid copolymer, ionomer of the ethylene/acrylic acid copolymer, ethylene vinyl acetate copolymer, polyethylene terephthalate, polypropylene, polyethylene, biaxally oriented nylon, or combinations of two or more thereof. The polyethylene terephthalate can be oriented polyethylene terephthalate and the polyethylene can be low density polyethylene (LDPE), linear low density polyethylene (LLDPE), high density polyethylene (HDPE), or combinations of two or more thereof.

The term micron (μ) is a dimension equal to 1/1000 of a millimeter. A micron is sometimes referred to as μm. The term mil equals to 1/1000 of an inch, 0.0254 mm, or 25.4μ.

Thermoplastic compositions are polymeric materials that can flow when heated under pressure. Melt index (MI) is the mass rate of flow, in g/10 minutes, of a polymer through a specified capillary under controlled conditions of temperature and pressure. Melt indices are determined according to ASTM 1238 at 190° C. using a 2160 g weight.

The term “metallized film” refers to a film or sheet of thermoplastic material with metal such as aluminum, deposited or vacuum deposited on at least one surface of the film. Some examples of thermoplastic films include those made from oriented polypropylene (OPP), cast polypropylene (CPP), oriented polyethylene terephthalate (OPET), biaxially-oriented nylon (BONY) and polyethylene (PE).

The term “ethylene copolymer” includes copolymers comprising repeat units derived from ethylene and one or more alkyl acrylates wherein the alkyl moiety contains from one to six carbon atoms. Examples of alkyl acrylates include methyl acrylate, ethyl acrylate and butyl acrylate. “Ethylene/methyl acrylate (EMA)” means a copolymer of ethylene (E) and methyl acrylate (MA). “Ethylene/ethyl acrylate (EEA)” means a copolymer of ethylene (E) and ethyl acrylate (EA). “Ethylene/butyl acrylate (EBA)” means a copolymer of ethylene (E) and butyl acrylate (BA). Of note are ethylene/butyl acrylate copolymers prepared from i-butyl acrylate comonomers (EiBA). Examples also include ethylene/butyl acrylate copolymers prepared from n-butyl acrylate comonomers (EnBA), ethylene/methyl acrylate copolymers, ethylene/ethyl acrylate copolymers, ethylene/alkyl acrylate copolymers other than ethylene/ethyl acrylate copolymers, and combinations of two or more thereof.

The relative amount of the alkyl acrylate comonomer incorporated into ethylene/alkyl acrylate copolymer can vary from 0.01 or 5 up to as high as 40 weight percent of the total copolymer or even higher. The choice of the alkyl group can vary from a simple methyl group up to a six-carbon atom alkyl group with or without branching. The amount and choice of the alkyl group present in the alkyl acrylate ester comonomer can be viewed as establishing how and to what degree the resulting ethylene copolymer is to be viewed as a polar polymeric constituent in the thermoplastic composition.

Preferably, the alkyl group in the alkyl acrylate comonomer has from one to four carbon atoms and the alkyl acrylate comonomer has a concentration range of from 5 to 30, or 10 to 25, weight percent of the ethylene/alkyl acrylate copolymer. The alkyl group in the alkyl acrylate comonomer can be n-butyl.

Ethylene/alkyl acrylate copolymers can be prepared by processes well known in the polymer art using either autoclave or tubular reactors. The copolymerization can be run as a continuous process in an autoclave as disclosed in U.S. Pat. Nos. 5,028,674 and 2,897,183. Because the processes are well known to one skilled in the art, the description of which is omitted herein for the interest of brevity.

Tubular reactor-produced ethylene/alkyl acrylate copolymer can be distinguished from the more conventional autoclave produced ethylene/alkyl acrylate as generally known in the art. Thus the term or phrase “tubular reactor produced” ethylene/alkyl acrylate copolymer denotes an ethylene copolymer produced at high pressure and elevated temperature in a tubular reactor or the like, wherein the inherent consequences of dissimilar reaction kinetics for the respective ethylene and alkyl acrylate comonomers is alleviated or partially compensated by the intentional introduction of the monomers along the reaction flow path within the tubular reactor. Tubular reactor produced ethylene copolymer are well known to one skilled in the art such as disclosed in U.S. Pat. Nos. 3,350,372; 3,756,996; and 5,532,066; the description of which is omitted herein for the interest of brevity. Tubular reactor produced ethylene/alkyl acrylate copolymers are generally stiffer and more elastic than autoclave produced ethylene/alkyl acrylate copolymers and are commercially available from E. I. du Pont de Nemours and Company, Wilmington, Del. (DuPont).

For additional discussion regarding the differences between tubular reactor produced and autoclave produced ethylene/alkyl acrylate copolymers, see Richard T. Chou, Mimi Y. Keating and Lester J. Hughes, “High Flexibility EMA made from High Pressure Tubular Process”, Annual Technical Conference—Society of Plastics Engineers (2002), 60^{th} (Vol. 2), 1832-1836.

The ethylene/alkyl acrylate copolymers useful in the present invention can vary in molecular weight as witnessed by ethylene/alkyl acrylate copolymers having a melt index numerically in terms of a fraction up to about ten such as 4.3-8 g/10 min.

The ethylene/alkyl acrylate compositions useful in this invention may optionally further comprise additives such as thermal and ultraviolet (UV) stabilizers, UV absorbers, antistatic agents, processing aids, fluorescent whitening agents, pigments, lubricants, etc. These conventional ingredients may be present in the compositions used in this invention in quantities that are generally from 0.01 to 20, or 0.1 to 15, weight %.

The ethylene/alkyl acrylate compositions useful in this invention may optionally further comprise from about 1 to about 30, or 5 to 25, or 10 to 20, weight %, preferably from 5 to 25 weight %, more preferably 10 to 20 weight % of a polyolefin, such as polyethylene or polypropylene.

The optional incorporation of such conventional ingredients into the compositions can be carried out by any known process such as, for example, by dry blending, by extruding a mixture of the various constituents, by the conventional masterbatch technique, or the like. The optional polyolefin may also be incorporated as part of a recycle process.

Polyolefins can include polypropylene or polyethylene polymers and copolymers comprising ethylene or propylene. Polyethylenes (PE) useful for use herein can be prepared by a variety of methods, including well-known Ziegler-Natta catalyst polymerization (see e.g., U.S. Pat. Nos. 4,076,698 and 3,645,992), metallocene catalyst polymerization (see e.g., U.S. Pat. Nos. 5,198,401 and 5,405,922) and by free radical polymerization. Polyethylene polymers can include HDPE, LLDPE, very low or ultra low density polyethylenes (VLDPE or ULDPE), and LDPE. The densities of polyethylenes range from 0.865 g/cc to 0.970 g/cc. “Polyethylene” refers to any or all of the polymers comprising ethylene described above.

Polypropylene (PP) polymers include homopolymers, random copolymers, block copolymers and terpolymers of propylene. Copolymers of propylene include copolymers of propylene with other olefins such as ethylene, 1-butene, 2-butene and the various pentene isomers, etc. and preferably copolymers of propylene with ethylene. Terpolymers of propylene include copolymers of propylene with ethylene and one other olefin. Random copolymers, also known as statistical copolymers, are polymers in which the propylene and the comonomer(s) are randomly distributed throughout the polymeric chain in ratios corresponding to the feed ratio of the propylene to the comonomer(s). Block copolymers are made up of chain segments consisting of propylene homopolymer and of chain segments consisting of, for example, random copolymer of propylene and ethylene. “Polypropylene refers to any or all of the polymers comprising propylene described above. PP can also be produced by well known processes such as Ziegler-Natta catalyst systems. Because the processes are well known, the description of which is omitted here for the interest of brevity.

This invention provides process for preparing a multilayer structure comprising at least one layer of metallized film; at least one layer of a composition comprising an ethylene/alkyl acrylate copolymer; and at least one other layer comprising a thermoplastic film or paper or paperboard.

The process is extrusion coating or lamination and involves laying down a molten curtain of the ethylene copolymer composition between the metallized film substrate and the second substrate moving at speed from about 100 to about 1000, or about 300 to about 800, feet per minute as they come into contact with a cold roll. The melt curtain can be formed by extruding the ethylene copolymer composition through a flat die. The temperature of the ethylene copolymer composition as it leaves the die can be between about 300 and 340° C., or about 310 to about 330° C. The air gap between the die exit and cold roll is typically about 3 to 15, or about 5 to about 10, inches. Higher temperatures can give higher adhesion values, subject to the limitations of the thermal stability of the polymer and the metallized film. Metallized film includes metallized OPET, PP, or PE film. Lower line speeds and higher air gaps may also favor adhesion. The time in the air gap (TIAG), defined as the air gap divided by the line speed, can be between about 50 and 100 milliseconds (ms) for adhesion in extrusion lamination. See V. Antonov and A. Soutar, 1991 TAPPI PLC Conference Proceedings, p 553. The laminate can be cooled on a cold roll and hauled off at a line speed of between about 100 and 1000, or about 300 and 800, feet/minute.

In some cases, extrusion coating of a metallized film with a molten curtain of the ethylene/alkyl acrylate copolymer composition without a second substrate, followed by contact with a cold roll can be used to prepare a multilayer structure comprising (a) at least one layer of metallized film (b) at least one layer of an ethylene copolymer composition.

Films useful in lamination processes of this invention can be made by any method for film forming known to those skilled in this art. The film can be either a single layer or multilayer polymeric film. As such, the film and film structures can be typically cast, extruded, co-extruded, laminated and the like, including orientation (either uniaxially or biaxially) by various methodologies (e.g., blown film, mechanical stretching or the like). Various additives generally practiced in the art can be present in the respective film layers including the presence of tie layers and the like, provided their presence does not substantially alter the adhesive properties of the film or film structure. The additives can be antioxidants and thermal stabilizers, ultraviolet (UV) light stabilizers, pigments and dyes, fillers, delustrants, anti-slip agents, plasticizers, anti-block agents, other processing aids, and the like may be advantageously employed.

The manufacture of a film can be carried out according to any known methods. It is possible, for example, to manufacture a primary film by extruding the said compositions using so-called “blown film” or “flat die” methods. A blown film is prepared by extruding the polymeric composition through an annular die and expanding the resulting tubular film with an air current to provide a blown film. Cast flat films are prepared by extruding the composition through a flat die. The film leaving the die is cooled by at least one roll containing internally circulating fluid (a chill roll) or by a water bath to provide a cast film. A film useful in this invention would have a width, for example, of about 60 cm (two feet) to 300 cm (ten feet).

A film can be further oriented beyond the immediate quenching or casting of the film. The process comprises the steps of extruding a laminar flow of molten polymer, quenching the extrudate and orienting the quenched extrudate in at least one direction. “Quenched” as the term is used herein describes an extrudate that has been substantially cooled below its melting point in order to obtain a solid film material.

The film can be unoriented, oriented in a uniaxial direction (e.g. machine direction), or oriented in a biaxial direction (e.g. machine direction and transverse direction). The film can be biaxially oriented by drawing in two mutually perpendicular directions in the plane of the film to achieve a satisfactory combination of mechanical and physical properties.

Orientation and stretching apparatus to uniaxially or biaxially stretch film are known in the art such as those disclosed in U.S. Pat. Nos. 3,278,663; 3,337,665; 3,456,044; 4,590,106; 4,760,116; 4,769,421; 4,797,235 and 4,886,634. Because the processes for making different films are well known to one skilled in the art, the description of which is omitted herein for the interest of brevity.

In one embodiment, the film is formed by an extrusion process that causes the polymer chains in the film to be generally aligned in the direction of extrusion. Linear polymers, after being highly oriented uniaxially possess considerable strength in the orientation direction, but less strength in the transverse direction. This alignment can add strength to the film in the direction of extrusion.

The films may be treated by means of corona discharge, ozone or other means standard in the industry. The film is laminated to a metallized film substrate using an ethylene copolymer composition as an adhesive layer to provide a multilayer structure. The adhesion of the multilayer structure can be improved by increasing the thickness of the ethylene copolymer layer. The thickness of the ethylene/alkyl acrylate layer can be about 10 to about 40μ (0.4 mil to 1.6 mil), or about 15 to about 30μ (0.6 to 1.2 mil) thick.

The invention provides a multilayer structure prepared by the above process comprising (a) at least one layer of metallized film; (b) at least one layer of an ethylene/alkyl acrylate copolymer composition; and (c) at least one substrate disclosed above.

The process can further comprise laminating at least one additional layer (d) onto the multilayer structure.

These multilayer structures can be prepared where a metallized film-containing substrate is adhered to a second substrate comprising a thermoplastic film (for example, comprising a polyolefin or polyester), paper or paperboard using an ethylene/alkyl acrylate copolymer composition as an adhesive layer. The metallized film-containing substrate, the second substrate, or both may be multilayer structures.

When the second substrate is a film comprising a polyolefin (PE or PP) layer to be adhered to the metallized film, ethylene/butyl acrylate, and especially EnBA, is the preferred ethylene/alkyl acrylate copolymer. Of note is a multilayer structure wherein the second substrate is a film comprising a polyolefin (PE or PP) layer to be adhered to the metallized film and the ethylene/alkyl acrylate copolymer is an ethylene/ethyl acrylate copolymer. Also of note is a multilayer structure wherein the second substrate is a film comprising a polyolefin (PE or PP) layer to be adhered to the metallized film and the ethylene/alkyl acrylate copolymer is a copolymer other than an ethylene/ethyl acrylate copolymer.

When the second substrate is a film comprising a polyester (e.g. OPET) layer to be adhered to the metallized film, EMA is the preferred ethylene/alkyl acrylate copolymer. Of note is a multilayer structure wherein the second substrate is a film comprising a polyester (e.g. OPET) layer to be adhered to the metallized film and the ethylene/alkyl acrylate copolymer is an ethylene/ethyl acrylate copolymer. Also of note is a multilayer structure wherein the second substrate is a film comprising a polyester (e.g. OPET) layer to be adhered to the metallized film and the ethylene/alkyl acrylate copolymer is a copolymer other than an ethylene/ethyl acrylate copolymer.

The multilayer structures can be useful in packaging applications as packaging materials or as industrial films (e.g., as a structural component in insulation sheeting).

The packaging materials may also be processed further by, for example but not limitation, printing, embossing, and/or coloring to provide a packaging material to provide information to the consumer about the product therein and/or to provide a pleasing appearance of the package. Such further processing is typically carried out before the lamination process described above, but may also be carried out after the lamination.

The packaging materials may be formed into packages, such as pouches, by standard methods well known in the art. Accordingly, this invention provides packages comprising multilayer structures as described above.

The following Examples are illustrative and are not to be construed as limiting the scope of the invention.

### EXAMPLES

General Procedures Used to Prepare the Laminates

The laminates were prepared using an extrusion laminating process. The metallized film substrate (Substrates A1 through A4) was combined with a second substrate (Substrates F1 and F2) using an adhesive layer B to provide a laminated multilayer structure A/B/F. The adhesive layer B was laid down between substrates A and F such that it contacted the metallized surface of Substrate A.

Substrate A1. In Examples 1-10 and Comparative Examples C1-C9, substrate A1 was prepared by vacuum deposition of aluminum onto a film of OPET to provide a metallized film (VMOPET) having a Class A wettable surface. The film was 48 gauge film available from DuPont Teijin Films as 48MM20.

Substrate A2. In Examples 11-15 and Comparative Examples C10-C14, substrate A2 was prepared by vacuum deposition of aluminum onto a film of OPP to provide a metallized film (VMOPP) having a >25% alcohol wettable surface. The film was 70 gauge film available from ExxonMobil as BSM-11.

Substrate A3. In Examples 16-18 and Comparative Examples C15-C17, substrate A3 was prepared by vacuum deposition of aluminum onto a film of OPET to provide a metallized film (VMOPET) having a Class A wettable surface. The film was available from China Novel Packaging.

Substrate A4. In Examples 19-20 and Comparative Examples C18-C19, substrate A4 was prepared by vacuum deposition of aluminum onto a film of OPET to provide a metallized film (VMOPET) having a Class A wettable surface. The film was available as GP61 from Korea.

Adhesive Layer B. The resins used for the lamination adhesive layer B in the Examples described below are listed in Table 1, where MA stands for methyl acrylate and BA stands for butyl acrylate. Resins b and c are ethylene/alkyl acrylate resins. Resin a was a polyethylene composition used as an adhesive composition in Comparative Examples C1-C19. Resin a can also be blended with an ethylene/alkyl acrylate resin to form an ethylene/alkyl acrylate-PE composition. Resin b was an ethylene/butyl acrylate copolymer available from DuPont having 27-weight % butyl acrylate and an MI of 4.3 g/10 min. Resin c was an ethylene methacrylate copolymer from DuPont having 20 weight % methacrylate and an MI of 8 g/10 min.

TABLE 1

| Resin | MI (g/10 min) | Co-monomer | Wt. % | Mole % | Comment |
|---|---|---|---|---|---|
| a | 7 | None | 0 | 0 | 0.918 g/cc, |
| | | | | | LDPE |
| b | 4 | BA | 27 | 7.4 | EBA-5 |
| c | 8 | MA | 20 | 8.3 | EMA-8 |

Substrate F1. In Examples 1-3 and Comparative Examples C1-C3, Substrate F1 was a 3.0-mil thick LDPE blown film.
Substrate F2. In Examples 4-20 and Comparative Examples C4-C19, Substrate F2 was a 2.0-mil thick polyethylene blown film made of 80% of a butene LLDPE (LL1001.32 from ExxonMobil) and 20% high pressure LDPE (Novapol PF0118 from Nova).

The laminate A/B/F was prepared by extruding the adhesive polymer for Layer B using a 4.5-inch diameter, 126-inch long, single-screw extruder. The extrudate from the extruder flowed through an ER-WE-PA feedblock with a 40-inch wide (internally deckled to 34 inches) Cloeren edge bead reduction die having a 30-mil gap, blade set at 1.5 inches and plug set at 2.25 inches. The adhesive layer B was laid down between substrates A and F such that it contacted the metallized film surface of Substrate A. The laminate A/B/F was prepared using an extruder exit temperature as indicated in Table 2, air gap of 5.3 inches except where noted, line speed of about 330 feet/minute (FPM), chill roll temperature of 50° F., lead-in of −0.6 inches, and nip pressure of 60 psig. The nip to chill roll contact across the 740 mm width was from about 13 to about 15 mm. The thickness of layer B was from about 0.5 to about 0.8 mils. The structures were processed according to the data in Table 2.

TABLE 2

| | | | | | |
|---|---|---|---|---|---|
| | | Extrusion | Tie Layer | | |
| | | Temperature | Thickness | | TIAG |
| Ex. | B resin | (° F.) | (mils) | FPM | (milliseconds) |

Multilayer Structure: A1/B/F1

| | | | | | |
|---|---|---|---|---|---|
| C1 | a | 547 | 0.5 | 329 | 80.55 |
| C2 | a | 575 | 0.6 | 328 | 80.79 |
| C3 | a | 609 | 0.6 | 329 | 80.55 |
| 1 | b | 616 | 0.8 | 329 | 80.55 |
| 2 | b | 586 | 0.8 | 328 | 80.79 |
| 3 | b | 545 | 0.8 | 329 | 80.55 |

Multilayer Structure: A1/B/F2

| | | | | | |
|---|---|---|---|---|---|
| 4 | b | 611 | 0.7 | 328 | 80.79 |
| C4 | a | 546 | 0.6-0.7 | 328 | 79.27* |
| C5 | a | 576 | 0.7 | 329 | 80.55 |
| C6 | a | 614 | 0.7 | 328 | 80.79 |
| 5 | c | 617 | 0.8 | 328 | 80.79 |
| 6 | c | 583 | 0.7 | 329 | 80.55 |
| 7 | c | 544 | 0.75 | 328 | 80.79 |
| C7 | a | 590 | 0.6-0.7 | 328 | 79.27* |
| C8 | a | 602 | 0.6-0.7 | 329 | 80.55 |
| C9 | a | 619 | 0.6-0.7 | 329 | 80.55 |
| 8 | b | 622 | 0.6-0.75 | 330 | 80.3 |
| 9 | b | 608 | 0.7-0.8 | 328 | 80.79 |
| 10 | b | 588 | 0.7 | 330 | 80.3 |

Multilayer Structure: A2/B/F2

| | | | | | |
|---|---|---|---|---|---|
| C10 | a | 584 | 0.7 | 330 | 80.3 |
| C11 | a | 617 | 0.6 | 330 | 80.3 |
| 11 | c | 619 | 0.7 | 328 | 80.79 |
| 12 | c | 585 | 0.75 | 329 | 80.55 |
| C12 | a | 586 | 0.6-0.7 | 329 | 80.55 |
| C13 | a | 599 | 0.6-0.7 | 329 | 80.55 |
| C14 | a | 616 | 0.6-0.7 | 329 | 80.55 |
| 13 | b | 621 | 0.75 | 329 | 80.55 |
| 14 | b | 605 | 0.6-0.7 | 329 | 80.55 |
| 15 | b | 587 | 0.6 | 329 | 80.55 |

Multilayer Structure: A3/B/F2

| | | | | | |
|---|---|---|---|---|---|
| C15 | a | 585 | 0.6-0.7 | 328 | 80.79 |
| C16 | a | 600 | 0.6-0.7 | 329 | 80.55 |
| C17 | a | 617 | 0.7 | 329 | 80.55 |
| 16 | b | 618 | 0.6 | 329 | 80.55 |
| 17 | b | 600 | 0.5-0.6 | 328 | 80.79 |
| 18 | b | 588 | 0.5-0.6 | 328 | 80.79 |

Multilayer Structure: A4/B/F2

| | | | | | |
|---|---|---|---|---|---|
| 19 | b | 604 | 0.6-0.7 | 329 | 80.55 |
| 20 | b | 619 | 0.6-0.7 | 328 | 80.79 |
| C18 | a | 617 | 0.5-0.6 | 328 | 80.79 |
| C19 | a | 601 | 0.5-0.6 | 328 | 80.79 |

*Air gap 5.2 inches

Tests Employed in Examples

Peel Strength: One-inch wide strips were cut in the machine direction from near the center of the laminate. The layers were separated at the A-B interface unless otherwise noted and pulled in a tensile tester at room temperature in a “T-peel” configuration at a separation speed of 12 inches/min. The average force required to separate the layers divided by the width was the peel strength. Five separate determinations were averaged together for a given mean value. Also shown is the standard deviation (Std Dev). See ASTM F904. Green peel strength was measured within four hours of producing the structure. Peel strength on the same sample was typically measured again after being stored in a 50% relative humidity, 23° C. controlled environment for four weeks.

The mode of failure in Table 3 was characterized by these descriptors. P=peels cleanly away from the substrate; LS=B/F film layers split; E=elongation of the peel arm as it is pulled away from the substrate; D=F layer peels from the B layer while B stays with layer A; FT=metallized film tear; and ML=Spotty metal lift (about 5%).

TABLE 3

| | Green adhesion, g/in | | | 4 week adhesion, g/in | | |
|---|---|---|---|---|---|---|
| Ex. | Mean | Std Dev | Failure Mode | Mean | Std Dev | Failure Mode |

Multilayer Structure: A1/B/F1

| C1 | Adhesion too weak to measure | | | | | |
|---|---|---|---|---|---|---|
| C2 | 57 | 8 | P | 17 | 7 | P |
| C3 | 212 | 8 | P | 195 | 5 | P |
| 1 | 565 | 18 | D | 716 | 18 | P |
| 2 | 432 | 13 | P | 336 | 11 | P |
| 3 | 71 | 6 | P | 4 | 0.3 | P |

Multilayer Structure: A1/B/F2

| 4 | 1075 | 69 | LS, LS/FT | 1141 | 80 | LS, FT |
|---|---|---|---|---|---|---|
| C4 | Adhesion too weak to measure | | | | | |
| C5 | 48 | 7 | P | 27 | 7 | P |
| C6 | 195 | 8 | P | 202 | 4 | P |
| 5 | 539 | 57 | P/FT | 492 | 180 | P/FT |
| 6 | 243 | 11 | P | 195 | 9 | P |
| 7 | 89 | 5 | P | 46 | 8 | P |
| C7 | 91 | 19 | P | 66 | 24 | P |
| C8 | 142 | 8 | P | 126 | 9 | P |
| C9 | 167 | 7 | P | 164 | 4 | P |
| 8 | 643 | 98 | P, P/FT | 464 | 10 | P/FT |
| 9 | 507 | 21 | P/FT | 455 | 42 | P, P/FT |
| 10 | 327 | 6 | P | 297 | 10 | P |

Multilayer Structure: A2/B/F2

| C10 | 26 | 2 | P | 12 | 4 | P |
|---|---|---|---|---|---|---|
| C11 | 78 | 4 | P | 132 | 6 | P |
| 11 | 113 | 7 | P | 167 | 6 | P |
| 12 | 69 | 3 | P | 111 | 6 | P |
| C12 | Adhesion too weak to measure | | | | | |
| C13 | 42 | 4 | P | 65 | 8 | P |
| C14 | 75 | 6 | P | 124 | 6 | P |
| 13 | 132 | 10 | P | 96 | 69 | P |
| 14 | 131 | 10 | P | 91 | 34 | P |
| 15 | 94 | 6 | P | 16 | 2 | Tack |

Multilayer Structure: A3/B/F2

| | | | | | | |
|---|---|---|---|---|---|---|
| C15 | 51 | 2 | P | 73 | 3 | P |
| C16 | 77 | 6 | P | 121 | 8 | P |
| C17 | 80 | 8 | P | 120 | 6 | P |
| 16 | 334 | 37 | P | 1025 | 92 | D |
| 17 | 333 | 13 | P | 207 | 64 | P |
| 18 | 182 | 88 | P | 41 | 6 | Tack |

Multilayer Structure: A4/B/F2

| | | | | | | |
|---|---|---|---|---|---|---|
| 19 | 346 | 12 | P | 648 | 45 | P |
| 20 | 326 | 12 | P, P/ML | 330 | 219 | P |
| C18 | 65 | 5 | P | 100 | 7 | P |
| C19 | 61 | 9 | P | 96 | 10 | P |

Inspection of the peel strength data in Table 3 showed that use of ethylene/alkyl acrylate copolymers as adhesive layers in lamination of metallized film to polyolefins provided better adhesion than LDPE and that this adhesion was maintained over time.

1. A multilayer structure comprising, or produced from, (a) at least one layer of metallized film; (b) at least one composition comprising or produced from an ethylene copolymer; (c) optionally at least one substrate, and (d) optionally at least one additional layer wherein the substrate comprises or is produced from a thermoplastic film, paper, paperboard, or combinations of two or more thereof; the additional layer comprises or is produced from polyester, polyamide, polyethylene vinyl alcohol, polyethylene vinyl acetate, ethylene/acrylic acid copolymer, ionomer of ethylene/acrylic acid copolymer, polyvinylidene chloride, anhydride-modified ethylene polymer, or combinations of two or more thereof; and the thermoplastic film comprising, or produced from, ethylene/acrylic acid copolymer, ionomer of the ethylene/acrylic acid copolymer, ethylene vinyl acetate copolymer, polyethylene terephthalate, polypropylene, polyethylene, biaxally oriented nylon, or combinations of two or more thereof.

2. The structure of claim 1 comprising the substrate wherein the composition comprises an ethylene/alkyl acrylate copolymer and from about 1 to about 30 weight % of a polyolefin.

3. The structure of claim 2 wherein the polyolefin is polyethylene or polypropylene.

4. The structure of claim 2 wherein the composition comprises an ethylene/methyl acrylate copolymer, an ethylene/ethyl acrylate copolymer, an ethylene/butyl acrylate copolymer, or combinations of two or more thereof.

5. The structure of claim 4 wherein the metal in the metallized film is aluminum.

6. The structure of claim 2 wherein the composition comprises a copolymer other than ethylene/ethyl acrylate copolymer.

7. The structure of claim 2 wherein the thermoplastic film comprises an oriented polyethylene terephthalate, polypropylene, high density polyethylene, biaxally oriented nylon, or combinations of two or more thereof.

8. The structure of claim 4 wherein the thermoplastic film comprises an oriented polyethylene terephthalate, polypropylene, high density polyethylene, biaxally oriented nylon, or combinations of two or more thereof.

9. The structure of claim 8 wherein the polyolefin is polyethylene or polypropylene.

10. The structure of claim 2 comprising the additional layer.

11. The structure of claim 10 wherein the composition comprises an ethylene/methyl acrylate copolymer, an ethylene/ethyl acrylate copolymer, an ethylene/butyl acrylate copolymer, or combinations of two or more thereof.

12. The structure of claim 11 wherein the thermoplastic film comprises polypropylene, high-density polyethylene, or both and the composition comprises ethylene/butyl acrylate copolymer, ethylene/ethyl acrylate copolymer, or both.

13. The structure of claim 12 wherein the ethylene copolymer is a tubular reactor-produced ethylene/alkyl acrylate copolymer.

14. A shaped article comprises of produced from a multilayer structure wherein the shaped article includes pouch and the structure is as recited in claim 2.

15. The shaped article claim 14 wherein the structure is as recited in claim 9.

16. The shaped article claim 14 wherein the structure is as recited in claim 10.

17. The shaped article claim 14 wherein the structure is as recited in claim 13.

18. A process comprising extruding an ethylene copolymer composition between a layer of metallized film and substrate wherein the composition and the substrate are each as recited in claim 1.

19. The process of claim 18 wherein the metal in the metallized film is aluminum and the composition and the substrate are each as recited in claim 9.

20. The process of claim 18 wherein the metal in the metallized film is aluminum and the composition and the substrate are each as recited in claim 13.
